(19) United States
(12) Patent Application Publication
(10) Pub. No.: US 2024/0254991 A1
(43) Pub. Date: Aug. 1, 2024

(54) COMPRESSOR AND METHOD FOR CONTROLLING THE SAME

(71) Applicant: Hanon Systems, Daejeon (KR)

(72) Inventors: Gu Hyun Ryu, Daejeon (KR); Chi Myeong Moon, Daejeon (KR); Kweon Soo Lim, Daejeon (KR); Chang Eon Park, Daejeon (KR); Hyun Seong Ahn, Daejeon (KR)

(21) Appl. No.: 18/260,819

(22) PCT Filed: May 19, 2022
(86) PCT No.: PCT/KR2022/007195

§ 371 Date: Mar. 14, 2024

(30) Foreign Application Priority Data
May 20, 2021 (KR) 10-2021-0064898

(51) Int. Cl. F04C 28/28; B60H 1/00; B60H 1/32; F04C 18/02

(52) U.S. Cl. CPC F04C 28/28; B60H 1/00807; B60H 1/3229; F04C 18/0215; F04C 2240/403; F04C 2270/18; F04C 2270/19; F04C 2270/70

(57) ABSTRACT

A compressor and a method for controlling the compressor detects the state of the suction refrigerant, thereby preventing the damage of the compressor and enabling stable operation. The compressor includes a compression unit equipped with a compression means for compressing a refrigerant, a motor unit coupled to the compression unit and compresses a suction refrigerant sucked through a suction port, an inverter unit with a detection unit for detecting a state of the suction refrigerant sucked through the suction port, and a control unit which controls the compression unit. The control unit controls by comparing a low flow condition which is set on the basis of a state in which the compression unit operates under an operating condition of a low refrigerant amount of the suction refrigerant and an actual flow condition of the suction refrigerant sucked into the motor unit when the compression unit is actually operated.

### CROSS REFERENCE TO RELATED PATENT APPLICATIONS

This is a U.S. national phase patent application of PCT/KR2022/007195 filed May 19, 2022 which claims the benefit of and priority to Korean Patent Application No. 10 2021 0064898 filed on May 20, 2021, the entire contents of each of which are incorporated herein by reference.

### TECHNICAL FIELD

The present disclosure relates to a compressor and more particularly to a compressor which is provided to an eco-friendly vehicle, protects the compressor by detecting a state of a suction refrigerant, and enables its stable operation, and a method for controlling the same.

### BACKGROUND ART

In general, briefly describing an air conditioning system of a vehicle, first, a high-temperature and low-pressure gaseous refrigerant becomes a high-temperature and high-pressure gaseous state by a compressor. The high-temperature and high-pressure gaseous refrigerant passes through a condenser and becomes a high-temperature and high-pressure liquid state by condensation of the condenser, and the high-temperature and high-pressure liquid refrigerant passes through an expansion valve and becomes a low-temperature and low-pressure liquid state by the throttling action of the expansion valve.

The low-temperature and low-pressure liquid refrigerant passes through an evaporator and returns to the high-temperature and low-pressure gaseous state through heat exchange which is performed in the evaporator. The high-temperature and low-pressure gas is compressed again by the compressor and becomes a high-temperature and high-pressure gaseous state. By repeatedly performing this process, the air conditioning system of the vehicle is operated.

The compressor for compressing the refrigerant include a reciprocating type compressor that actually compresses a working fluid while performing a reciprocating motion and a rotary type compressor that actually compresses the working fluid while performing a rotational motion.

The reciprocating type compressor includes a crank type compressor that transmits a driving force of a driving source to a plurality of pistons by using a crank, a swash plate type compressor that transmits the driving force by using a rotary shaft on which a swash plate is installed, and a wobble plate type compressor that uses a wobble plate.

The rotary type compressor includes a vane rotary type compressor that uses a rotating rotary shaft and a vane, and a scroll type compressor that uses a rotating scroll and a fixed scroll.

Among these compressors, a compressor that uses an electric motor as a power source is generally referred to as an electric compressor. Among compressor types, the swash plate type compressor is being widely used in an air conditioning system of a vehicle.

The above-mentioned compressor relates to a compressor installed in an internal combustion engine vehicle. Recently, with the development of technology and the spread of infrastructure, the compressor is installed in from a hybrid electric vehicle to a plug-in hybrid electric vehicle and is also installed in an eco-friendly vehicle such as a pure electric vehicle. Also, a new drive type compressor that is different from the conventional internal combustion engine vehicle is being used.

### Patent Document

Japanese Patent Application Laid-open No. 2019-174048

The purposes of embodiments of the present disclosure are to provide a compressor capable of preventing damage thereto and of improving efficiency by preventing in advance risk factors such as a lack of cooling or a lack of lubrication that may occur due to a lack of amount of suction refrigerant when the compressor installed in an eco-friendly vehicle is operated, and a method for controlling the same.

### SUMMARY

One embodiment is a compressor including: a compression unit 5 which is equipped with a compression means for compressing a refrigerant; a motor unit 3 which is coupled to the compression unit 5 and compresses a suction refrigerant sucked through a suction port 22; an inverter unit 50 which is coupled to the motor unit 3 and is equipped with a detection unit 80 for detecting a state of the suction refrigerant sucked through the suction port 22; and a control unit 100 which determines the state of the suction refrigerant in real time on the basis of a signal detected by the detection unit 80 and controls the compression unit 5. The control unit 100 controls by comparing a low flow condition which is set on the basis of a state in which the compression unit 5 operates under an operating condition of a low refrigerant amount of the suction refrigerant and an actual flow condition of the suction refrigerant sucked into the motor unit 3 when the compression unit 5 is actually operated.

The motor unit is provided with the detection unit and the detection unit detects a state of the suction refrigerant.

The low flow condition is set based on a state in which the compressor operates under the operating condition of a low refrigerant amount.

The detection unit 80 includes: a first detection unit 82 for detecting a pressure of the suction refrigerant; and a second detection unit 84 for detecting a temperature of the suction refrigerant. The low flow condition is obtained by applying a corrected density value of the suction refrigerant to a pressure corresponding to the temperature of the suction refrigerant measured by the first detection unit 82.

A density value corresponding to 40% of a total density value corresponding to the pressure of the suction refrigerant is applied as the corrected density value.

When the pressure of the suction refrigerant of the actual flow condition of the suction refrigerant is lower than the low flow condition, it is determined that an amount of refrigerant sucked into the motor unit 3 is reduced.

When the suction refrigerant has a relatively lower suction pressure than the low flow condition, the control unit 100 controls the motor unit 3 such that revolutions per minute (RPM) of the compression unit 5 is reduced.

When the suction refrigerant has a relatively lower suction pressure than the low flow condition, the control unit 100 checks whether revolutions per minute (RPM) of the compression unit 5 is minimum revolutions per minute (RPM), and then controls the motor unit 3.

When the revolutions per minute (RPM) of the compression unit 5 is maintained to be minimum RPM, the control unit 100 fixes the revolutions per minute, when a suction pressure of the refrigerant is higher than the low flow condition after waiting t seconds, the control unit continues to operate the compression unit 5, and when the suction pressure of the refrigerant is lower than the low flow condition, the control unit stops the operation of the compression unit 5.

The first detection unit 82 and the second detection unit 84 are disposed apart from the inverter unit 50 by a shortest distance are connected to the control unit 100 through the medium of a wiring harness.

The compressor according to the embodiment can be installed and used in a vehicle air conditioner.

Another embodiment is a method for controlling a compressor. The method includes: a first step ST100 of determining a power state of the compressor, a second step ST200 of detecting the pressure and temperature of the suction refrigerant sucked into the compressor, a third step ST300 of comparing the actual flow condition of the detected suction refrigerant and a predetermined low flow condition and determining whether the compressor currently corresponds to the low flow condition; and a fourth step ST400 of controlling an actual suction pressure to rise when the compressor currently corresponds to the low flow condition.

The third step ST300 includes: a first determination step ST310 of determining whether the temperature of the suction refrigerant is within a normal range and the pressure of the suction refrigerant is within a normal range; and a second determination step ST320 of determining whether the temperature of the suction refrigerant is within a normal range and the pressure of the suction refrigerant corresponds to a relatively lower pressure condition than a pressure of the low flow condition.

The fourth step ST400 further comprises a first revolutions per minute control step ST410 of controlling revolutions per minute of the compressor to decrease after waiting t seconds.

The fourth step ST400 further comprises a second revolutions per minute control step ST420 of stopping an operation of the compressor when revolutions per minute of the compressor after waiting t seconds is lower than revolutions per minute in the low flow condition.

According to the embodiments of the present disclosure, a compressor installed in an eco-friendly vehicle determines the state of the suction refrigerant and ensures a stable operation of the compressor under optimal conditions, thereby preventing breakdowns and malfunctions in advance.

According to the embodiments of the present disclosure, a compressor detects both the pressure and temperature of the suction refrigerant and prevents in advance operations caused by lacks of cooling and lubrication due to a lack of amount of suction refrigerant, so that it is possible to protect the compressor having improved stability and to provide protection throughout an air conditioning system.

### DESCRIPTION OF DRAWINGS

FIG. 1 is a cross-sectional view of a compressor according to an embodiment of the present disclosure;

FIG. 2 is a view showing the outside of the compressor according to the embodiment of the present disclosure;

FIG. 3 is a view showing a motor unit, an inverter unit, and a detection unit of the compressor according to the embodiment of the present disclosure;

FIG. 4 is a view showing the motor unit of the compressor according to the embodiment of the present disclosure;

FIG. 5 is a view showing a P-H diagram of the compressor according to the embodiment of the present disclosure;

FIG. 6 is a flowchart showing a method for controlling the compressor according to the embodiment of the present disclosure; and

FIG. 7 is an operation flowchart by the method for controlling the compressor according to the embodiment of the present disclosure.

### DESCRIPTION OF AN EMBODIMENT

A compressor according to an embodiment of the present disclosure will be described with reference to accompanying drawings.

Also, the following embodiments are provided as examples in order to sufficiently transfer the spirit of the present invention to those skilled in the art. Accordingly, the present invention can be embodied in other forms without being limited to the embodiments described below. Also, in the drawings, the size, thickness, etc., of a device may be exaggerated for convenience. Throughout the disclosure, the same references mean the same components.

The features, advantages and method for accomplishment of the disclosed embodiment will be more apparent from referring to the following embodiments described as well as the accompanying drawings.

However, the present invention is not limited to the embodiment to be disclosed below and is implemented in different and various forms. The embodiments bring about the complete disclosure of the present invention and are only provided to make those skilled in the art fully understand the scope of the present invention. The same reference numerals throughout the disclosure correspond to the same elements. In the drawings, the sizes and relative sizes of each layer and area may be exaggerated for clarity of the description.

Terms used in the present specification are provided for description of only specific embodiments of the present invention, and not intended to be limiting. In the present specification, an expression of a singular form includes the expression of plural form thereof if not specifically stated. The terms “comprises” and/or “comprising” used in the specification is intended to specify characteristics, numbers, steps, operations, components, parts or any combination thereof which are mentioned in the specification, and intended not to exclude the existence or addition of at least one another characteristics, numbers, steps, operations, components, parts or any combination thereof.

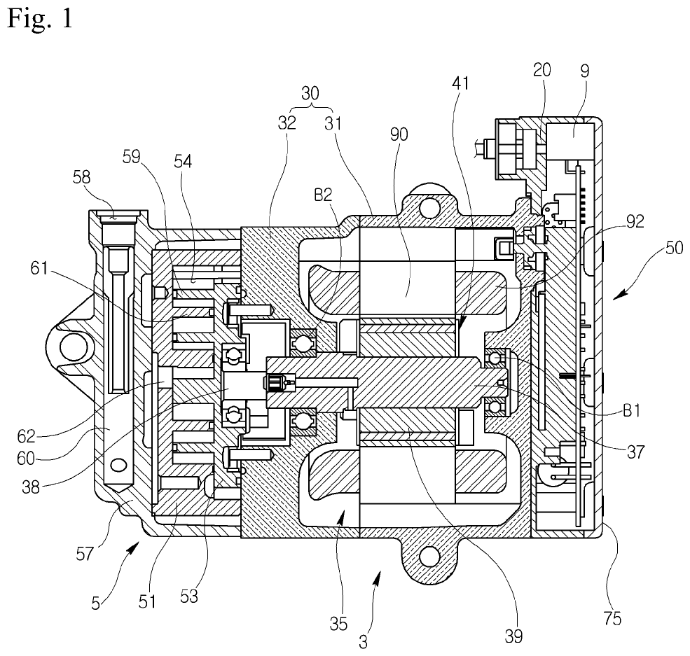

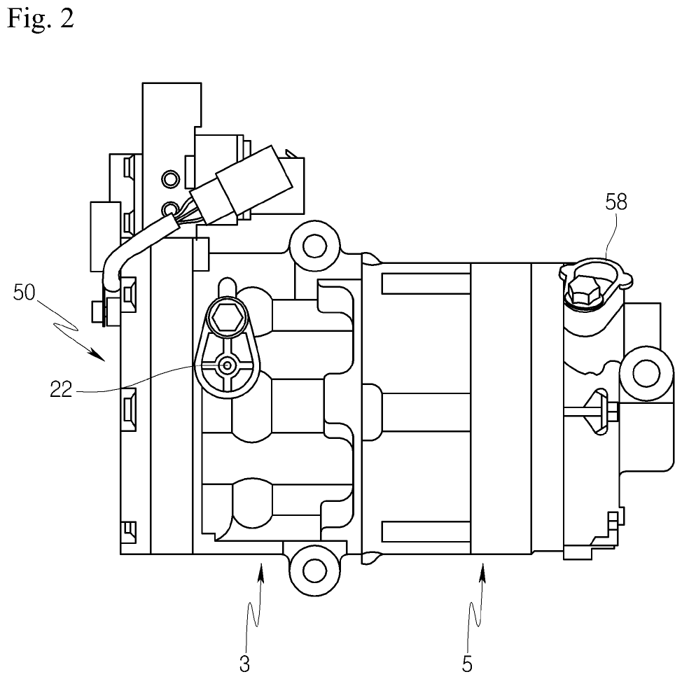

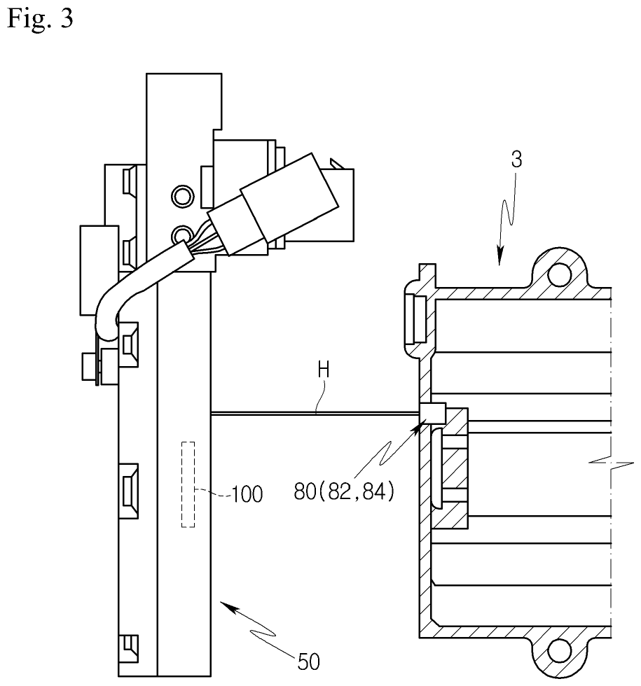

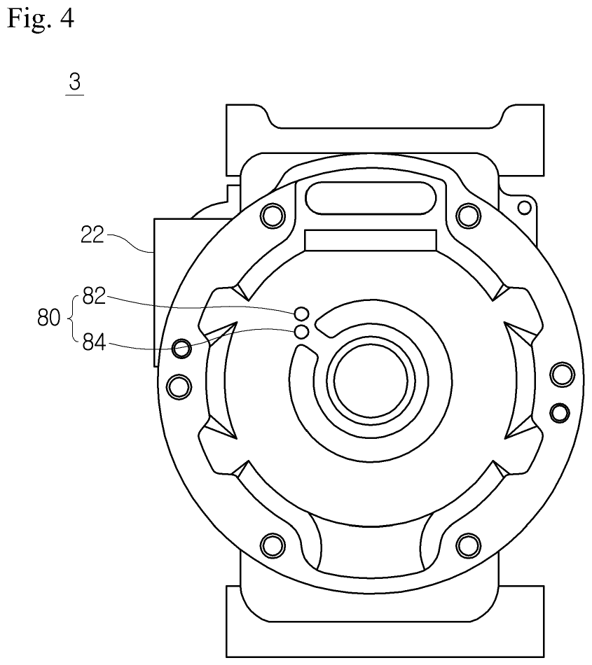

For reference, FIG. 1 is a cross-sectional view of a compressor according to an embodiment of the present disclosure. FIG. 2 is a view showing the outside of the compressor according to the embodiment of the present disclosure. FIG. 3 is a view showing a motor unit, an inverter unit, and a detection unit of the compressor according to the embodiment of the present disclosure. FIG. 4 is a view showing the motor unit of the compressor according to the embodiment of the present disclosure.

Referring to FIGS. 1 to 4, the compressor according to the embodiment of the present disclosure is used to obtain stable drivability of the compressor under low flow and low lubrication conditions due to a complex system of an eco-friendly vehicle and the requirement for protection logic according to the expansion of the operating range, and is used to prevent damage.

For example, the embodiment uses a scroll compressor. Also, other compressors can be applied to the embodiment without being limited to the compressor shown in the drawing.

The compressor according to the embodiment of the present disclosure includes a compression unit 5 which is equipped with a compression means for compressing a refrigerant; a motor unit 3 which is coupled to the compression unit 5 and compresses a suction refrigerant sucked through a suction port 22; an inverter unit 50 which is coupled to the motor unit 3 and is equipped with a detection unit 80 for detecting a state of the suction refrigerant sucked through the suction port 22; and a control unit 100 which determines the state of the suction refrigerant in real time on the basis of a signal detected by the detection unit 80 and controls the compression unit 5.

In addition, the control unit 100 controls by comparing an actual flow condition of the suction refrigerant sucked into the motor unit 3 when the compression unit 5 is actually operated and the actual flow condition of the suction refrigerant sucked into the motor unit 3 when the compression unit 5 is operated in a low flow condition. The low flow condition is set based on a state in which the compressor operates under an operating condition of a low refrigerant amount.

The control unit 100 controls by comparing the low flow condition which is set on the basis of a state in which the compression unit 5 operates under an operating condition of a low refrigerant amount of the suction refrigerant and the actual flow condition of the suction refrigerant sucked into the motor unit 3 when the compression unit 5 is actually operated, thereby preventing damage to the compressor under the condition that the cooling and lubrication performance of the compressor may be reduced due to the reduced amount of the suction refrigerant.

The compression unit 5 compresses the refrigerant by rotating by a rotational driving force generated by the motor unit 3. The compression unit 5 includes an orbiting scroll 53 and a fixed scroll 51 which is rotatably coupled to the orbiting scroll 53 and compress and discharges the refrigerant to the outside of the compressor 1.

The compression unit 5 is a cylindrical body open toward the motor unit 3. The compression unit 5 separates the refrigerant into a gas phase and a liquid phase through a gas-liquid separation pipe 60 and discharges the compressed gaseous refrigerant through a discharge port 58 opened on one side.

The orbiting scroll 53 has a protruding orbiting scroll wrap 59 which is curved in a spiral shape so as to converge toward the center thereof. An eccentric shaft 38 of a rotary shaft 37 is coupled to a central portion of the orbiting scroll wrap 59. Also, the orbiting scroll 53 revolves around the rotary shaft 37 in synchronization with a rotor 41.

The fixed scroll 51 forms a compression chamber 54 when assembled with the orbiting scroll 53. A fixed scroll wrap 61 which is curved in a spiral shape so as to converge toward the center such that the fixed scroll 51 matches the scroll wrap 59 of the orbiting scroll 53.

Therefore, when the orbiting scroll 53 rotates, the mutually matched orbiting scroll 53 and the fixed scroll 51 compress, into the center, the refrigerant sucked into the outer edges of the orbiting and fixed scroll wraps 59 and 61 from the motor unit 3, by the interaction of the orbiting and fixed scroll wraps 59 and 61, and then discharges the refrigerant to a compressor housing 57 through the discharge port 58 in a high-pressure state.

The motor unit 3 is a driving source for generating a rotational force of the compressor for compressing the refrigerant, and includes a driving part housing 30 constituting an exterior of the motor unit, a stator 90 fixed within the driving part housing 30, and the rotor 41 rotating within the stator 90.

The driving part housing 30 constitutes the outer body of the motor unit 3 and is formed in a cylindrical shape. The driving part housing 30 includes a front housing 32 supporting a front end portion of the rotor 41 and a rear housing 31 supporting a rear end portion of the rotor 41.

The stator 90 is an electromagnet that generates a rotational driving force together with the rotor 41 mounted coaxially in the inside, and includes a stator core fixed and mounted on an inner circumferential surface of the driving part housing 30 by press-fitting, etc., and a stator coil 92 wound on the stator core.

The stator core is a hollow cylindrical member. A through-hole into which the rotor 41 is inserted is formed on a central axis line of the stator core.

Also, the rotor 41 is a part coaxially mounted in the inside of the stator 90 and rotationally driven. The rotor 41 is rotatably inserted into the through-hole at the center of the stator core of the stator 90.

The rotary shaft 37 is inserted into the rotor 41 along the central axis line, and a rotor core 39 is coupled to an outer circumferential surface of the rotary shaft 37. When the stator 90 is excited, the rotor 41 is rotationally driven by interaction with the stator 90 according to a driving principle of the motor, and the rotary shaft 37 is rotatably supported through bearings B1 and B2 by the driving part housing 30.

The control unit 100 controls the operation of the motor unit 3 and is mounted on one side of the driving part housing 30 by a cover housing 75 in a state of being mounted on a PCB provided within the inverter unit 50 to be described later.

The control unit 100 is electrically connected to a terminal assembly of the stator 90 and excites or demagnetizes the stator 90 by external power supplied through a pair of connectors 20, so that the rotor 41 can be rotationally driven or stopped.

External power is applied to the control unit 100 through the pair of connectors 20, and the connector 20 and the control unit 100 are provided with an intermediate member 9 structurally coupled thereto through a terminal block. The intermediate member 9 is coupled to the connector 20 in an attachable and detachable manner by a fastening means such as a bolt, etc.

The detection unit 80 is coupled to the motor unit 3 and is provided to detect a pressure of the suction refrigerant. For example, the detection unit 80 includes a first detection unit 82 for detecting a pressure of the suction refrigerant and a second detection unit 84 for detecting a temperature of the suction refrigerant. For example, a pressure sensor is used as the first detection unit 82 and a temperature sensor is used as the second detection unit 84.

The first and second detection units 82 and 84 are disposed apart from the inverter unit 50 by the shortest distance and are connected to the control unit 100 through the medium of a wiring harness H, so that the state of the suction refrigerant can be accurately detected.

The first and second detection units 82 and 84 are located at a position adjacent to the suction port 22 in the inside of the rear housing 31, and an insertion hole (not shown) is machined such that the detection units are installed in the rear housing 31. Then, a finishing treatment is performed through a sealing member such as a gasket (not shown) or an O-ring (not shown).

According to the embodiment, a condition where the compressor operates under the operating condition of a low refrigerant amount is set to the low flow condition. Then, when the compressor is operated in various environments, it is determined whether the refrigerant amount is reduced or not by detecting the temperature and pressure of the suction refrigerant sucked into the suction port 22. After that, the compressor can be protected by performing revolutions per minute or by stopping the operation of the compressor.

For example, the low flow condition is selected by applying a corrected density value of the suction refrigerant to a pressure corresponding to the temperature of the suction refrigerant measured by the first detection unit 82.

For example, a density value corresponding to 40% of a total density value corresponding to the pressure of the suction refrigerant is applied as the corrected density value.

The reason why a criterion of the low flow condition is defined as described above is that because while a sufficient amount of refrigerant for stable operation of the compressor is maintained in the suction refrigerant normally sucked through the suction port 22, the amount of refrigerant for stable operation of the compressor becomes insufficient in the suction refrigerant sucked in the relatively low flow condition.

As such, the insufficient amount of refrigerant also causes the reduction of a density corresponding to the mass of a material per unit volume, so that cooling due to friction of the compressor becomes disadvantageous and the amount of oil also decreases to cause friction. Therefore, the low flow condition is determined by applying the corrected density (defined as 40% in this embodiment).

In addition, in this embodiment, on the basis of a normal amount of the suction refrigerant, the corrected density value is described as being obtained by arithmetically calculating an insufficient amount of the suction refrigerant or calculated through simulation. Also, an error value within a certain range may be applied. For example, an error value of ±5% may be applied to the above-described corrected density value and may vary according to various specifications of the compressor.

In this embodiment, temperature information of the suction refrigerant detected by the second detection unit 84 together with the first detection unit 82 is input as an important variable for the control of the controller 100.

The temperature of the suction refrigerant may fluctuate for various reasons. For example, the temperature of the suction refrigerant may fluctuate according to a temperature of an engine room, a load state of the compressor, or a load state of the vehicle, or when an error or failure occurs in a condenser and an evaporator. Therefore, in consideration of all of the above reasons, the temperature of the suction refrigerant acts as an important variable for stable operation of the compressor.

For example, the control unit 100 can determine a more exact state of the amount of the suction refrigerant that has been currently sucked, by using the temperature information of the suction refrigerant detected by the second detection unit 84 as additional information rather than by determining the flow condition of the suction refrigerant only by pressure information detected by the first detection unit 82.

In this case, by the improvement of the accuracy of the control unit 100, the improvement of the operation stability of the compressor, and prevention of failure of the compressor in advance, the operation of the expensive compressor is prevented in advance from being stopped due to the failure and the compressor is protected. As a result, the compressor is able to stably operate even when used for a long period of time.

The temperature of the suction refrigerant falls when the compressor is turned on, and rises when the compressor is turned off. In a season such as summer where an air temperature rises to a high temperature, the temperature of the engine room is also maintained high and a pressure change occurs. Therefore, it is more advantageous in terms of obtaining the stability of the compressor to utilize the temperature information together as well as the pressure information rather than to utilize only the pressure information as information for the stable operation of the compressor.

In addition, since the corrected density value is used as additional decision information, accuracy and stability are improved compared to a case of performing compressor control depending only on the pressure information of the existing suction refrigerant.

In this way, according to the present embodiment, when the low flow condition of the suction refrigerant is in advance set to the condition of insufficient amount of the suction refrigerant and then the compressor actually operates, the detection unit 80 detects in real time the actual flow condition of the suction refrigerant flowing into the motor unit 20 through the suction port 22.

Also, when the pressure of the suction refrigerant is lower than the low flow condition, it is determined that the amount of refrigerant sucked into the motor unit 3 is reduced.

When the suction refrigerant has a relatively lower suction pressure than a predetermined pressure as a pressure of the low flow condition, the control unit 100 according to the embodiment of the present disclosure may control the motor unit 3 such that the revolutions per minute (RPM) of the compression unit 5 is reduced. Thus, the pressure of the suction refrigerant is reduced and the compressor is operated.

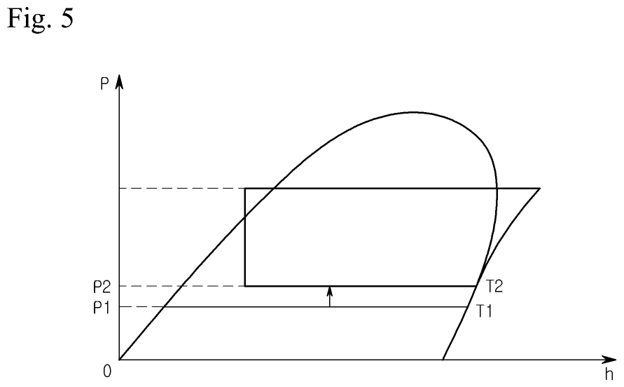

Referring to the attached FIG. 5 as an example, when the suction refrigerant is introduced through the suction port 22 at a first pressure P1 in a P-H diagram, the temperature is maintained at a first temperature T1. For reference, the X-axis represents the enthalpy of the refrigerant, and the Y-axis represents the pressure of the refrigerant.

Since the first pressure P1 corresponds to a pressure relatively lower than a low flow pressure set in the low flow condition, the control unit 100 controls the revolutions per minute (RPM) to decrease, and performs the compressor control according to the suction pressure.

In this case, when the compressor is controlled such that the suction pressure gradually rises from the first pressure P1 to a second pressure P2 by reducing the revolutions per minute, the temperature also rises from the first temperature T1 to a second temperature T2. Therefore, not only the suction pressure increases but also the flow rate of the suction refrigerant increases, so that the stable operation of the compressor can be ensured.

In this case, in the suction refrigerant of which the suction pressure has risen to the second pressure P2, the amount the suction refrigerant which allows the refrigerant to be stably compressed can be obtained, and the amount of oil for lubrication can be obtained. Accordingly, the compressor can operate normally and the damage of the compressor can be prevented.

When the suction refrigerant has a relatively lower suction pressure than the low flow condition, the control unit 100 checks whether the revolutions per minute (RPM) of the compression unit 5 is minimum revolutions per minute (RPM), and then controls the motor unit 3.

The control unit 100 does not adjust the revolutions per minute simply because the suction pressure of the compressor is reduced. The control unit 100 further checks whether or not the minimum revolutions per minute is present, and then controls the motor unit 3. A case where the minimum revolutions per minute temporarily changes is limited to an event and is not used as data for controlling the motor unit 3. Only when the minimum revolutions per minute lasts for a certain period of time or longer, the minimum revolutions per minute is used as control data for the motor unit 3.

The compressor includes an expansion valve. When the flow of the refrigerant becomes unstable at a specific location, the expansion valve may maintain a state in which the revolutions per minute of the compressor is maintained to be minimum.

In this case, the control unit 100 controls by determining whether the reason why the suction pressure is currently maintained low is that the suction refrigerant is sucked at a low suction pressure or operation errors occur while the minimum revolution per minute is maintained due to the occurrence of a failure in the evaporator.

For example, when the revolutions per minute (RPM) of the compression unit 5 is maintained to be the minimum RPM, the control unit 100 fixes the revolutions per minute. When the suction pressure of the refrigerant is higher than the low flow condition after waiting t seconds, the control unit 100 continues to operate the compression unit 5. When the suction pressure of the refrigerant is lower than the low flow condition, the control unit 100 stops the operation of the compression unit 5.

When the control unit 100 controls in this way, the low flow control can be performed in consideration of various risk factors, including the pressure condition of the suction refrigerant and whether or not the compressor components are abnormal, thereby minimizing unnecessary friction during the operation and preventing wear and noise of the components due to a lack of oil, so that it is possible to ensure the stable operation.

This embodiment can be applied to and used in a vehicle air conditioner in which the above-described compressor is installed, and the vehicle air conditioner may include an eco-friendly vehicle.

A method for controlling the compressor according to the embodiment of the present disclosure will be described with reference to the drawings.

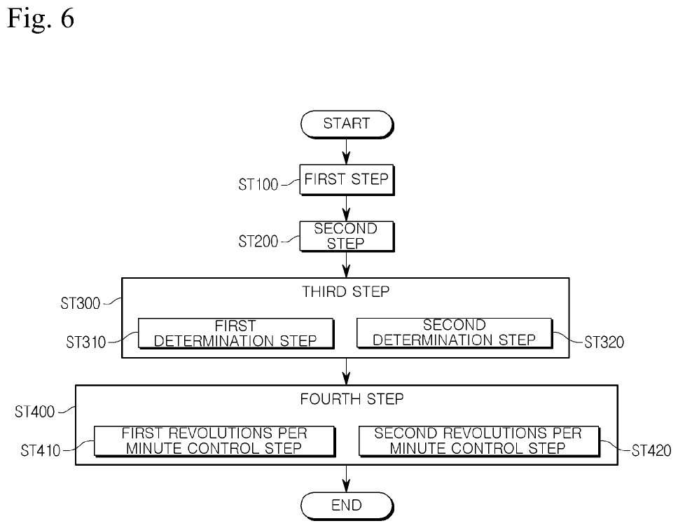

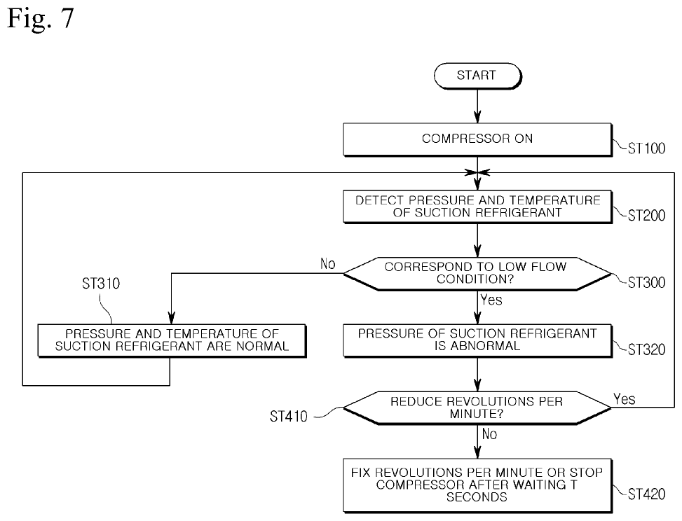

Referring to the attached FIGS. 6 and 7, the method for controlling the compressor according to the embodiment of the present disclosure includes: a first step ST100 of determining a power state of the compressor, a second step ST200 of detecting the pressure and temperature of the suction refrigerant sucked into the compressor, a third step ST300 of comparing the actual flow condition of the detected suction refrigerant and a predetermined low flow condition and determining whether the compressor currently corresponds to the low flow condition; and a fourth step ST400 of controlling an actual suction pressure to rise when the compressor currently corresponds to the low flow condition.

The aforementioned control unit determines whether the compressor is in an on or off state before controlling the compressor (ST100). For example, when the compressor is in an on state, the suction refrigerant is sucked through the suction port, and then the pressure and temperature of the suction refrigerant are detected.

As described above, the pressure and temperature of the suction refrigerant are detected by the above-mentioned detection unit and transmitted to the control unit through the harness in order that the compressor operates under the low flow condition (ST200).

In this embodiment, it is determined whether the current condition of the suction refrigerant corresponds to the low flow condition by applying the corrected density value of the suction refrigerant to the pressure and temperature of the suction refrigerant and the pressure corresponding to the temperature of the suction refrigerant (ST300).

For example, the third step ST300 includes a first determination step ST310 of determining whether the temperature of the suction refrigerant is within a normal range and the pressure of the suction refrigerant is within a normal range, and a second determination step ST320 of determining whether the temperature of the suction refrigerant is within a normal range and the pressure of the suction refrigerant corresponds to a relatively lower pressure condition than the pressure of the low flow condition.

In the first determination step ST310, since the temperature and pressure of the suction refrigerant are within a normal range, the compressor operates stably without insufficient flow rate or insufficient oil for lubrication.

In the second determination step ST310, when it is determined that the temperature of the suction refrigerant is within a normal range and the pressure of the suction refrigerant is lower than the pressure of the low flow condition, it is determined that the amount of the suction refrigerant for the stable operation of the compressor is insufficient.

In this case, the control unit waits t seconds to increase the actual suction pressure of the suction refrigerant, and then controls the revolutions per minute of the compressor to decrease, first revolutions per minute control is performed to increase the pressure of the suction refrigerant (ST410). The t seconds are applied differently depending on the specifications of the compressor. For example, the t seconds are variously selected from 10 seconds or from a time period less than 10 seconds.

If the revolutions per minute of the compressor is lower than the revolutions per minute in the low flow condition after waiting t seconds, second revolutions per minute control is performed to stop the operation of the compressor (ST420).

The second revolutions per minute control is performed as described above in order to protect the components constituting the compressor, and prevents additional failure. Therefore, it is possible to ensure to stably use the compressor.

In particular, the compressor can be protected from malfunction and damage in consideration of the complex system and various operating ranges of an eco-friendly vehicle.

While the one embodiment of the present invention has been described, it is possible for those skilled in the art to make various changes and modifications of the forms and details of the present invention by means of addition, change, elimination or supplement, etc., of the components of the present invention without departing from the spirit of the present invention.

### REFERENCE NUMERALS

3: Motor Unit
5: Compression Unit
22: Suction Port
50: Inverter Unit
80: Detection Unit
82, 84: First and Second Detection Units
100: Control Unit

1-15. (canceled)

16. A compressor comprising:
a compression unit equipped with a compression means for compressing a refrigerant;
a motor unit coupled to the compression unit and compresses a suction refrigerant sucked through a suction port;
an inverter unit coupled to the motor unit equipped with a detection unit for detecting a state of the suction refrigerant sucked through the suction port; and
a control unit which determines the state of the suction refrigerant in real time on a basis of a signal detected by the detection unit and controls the compression unit, wherein the control unit controls by comparing a low flow condition which is set on a basis of a state in which the compression unit operates under an operating condition of a low refrigerant amount of the suction refrigerant and an actual flow condition of the suction refrigerant sucked into the motor unit when the compression unit is operated.

17. The compressor of claim 16, wherein the motor unit is provided with the detection unit and the detection unit detects the state of the suction refrigerant.

18. The compressor of claim 16, wherein the low flow condition is set based on the state in which the compressor operates under the operating condition of the low refrigerant amount.

19. The compressor of claim 17, wherein the detection unit further comprises:
a first detection unit for detecting a pressure of the suction refrigerant; and
a second detection unit for detecting a temperature of the suction refrigerant, wherein the low flow condition is obtained by applying a corrected density value of the suction refrigerant to a pressure corresponding to the temperature of the suction refrigerant measured by the first detection unit.

20. The compressor of claim 19, wherein a density value corresponding to 40% of a total density value corresponding to the pressure of the suction refrigerant is applied as the corrected density value.

21. The compressor of claim 19, wherein, when the pressure of the suction refrigerant of the actual flow condition of the suction refrigerant is lower than the low flow condition, it is determined that an amount of the refrigerant sucked into the motor unit is reduced.

22. The compressor of claim 16, wherein, when the suction refrigerant has a relatively lower suction pressure than the low flow condition, the control unit controls the motor unit such that revolutions per minute (RPM) of the compression unit is reduced.

23. The compressor of claim 16, wherein, when the suction refrigerant has a relatively lower suction pressure than the low flow condition, the control unit checks whether revolutions per minute (RPM) of the compression unit is minimum revolutions per minute (RPM), and then controls the motor unit.

24. The compressor of claim 16, wherein, when revolutions per minute (RPM) of the compression unit is maintained to be minimum RPM, the control unit fixes the revolutions per minute, when a suction pressure of the refrigerant is higher than the low flow condition after waiting t seconds, the control unit continues to operate the compression unit, and when the suction pressure of the refrigerant is lower than the low flow condition, the control unit stops the operation of the compression unit.

25. The compressor of claim 19, wherein the first detection unit and the second detection unit are disposed apart from the inverter unit by a shortest distance and are connected to the control unit through a wiring harness.

26. A vehicle air conditioner in which the compressor of claim 16 is installed.

27. A method for controlling a compressor, the method comprising steps of:
a first step of determining a power state of the compressor,
a second step of detecting a pressure and a temperature of a suction refrigerant sucked into the compressor,
a third step of comparing an actual flow condition of the suction refrigerant detected and a predetermined low flow condition and determining whether the compressor currently corresponds to the predetermined low flow condition; and
a fourth step of controlling an actual suction pressure to rise when the compressor currently corresponds to the predetermined low flow condition.

28. The method of controlling a compressor of claim 27, wherein the third step further comprises:
a first determination step of determining whether the temperature of the suction refrigerant is within a normal range and the pressure of the suction refrigerant is within a normal range; and
a second determination step of determining whether the temperature of the suction refrigerant is within a normal range and the pressure of the suction refrigerant corresponds to a relatively lower pressure condition than a pressure of the predetermined low flow condition.

29. The method of controlling a compressor of claim 27, wherein the fourth step further comprises a first revolutions per minute control step of controlling revolutions per minute of the compressor to decrease after waiting t seconds.

30. The method of controlling a compressor of claim 29, wherein the fourth step further comprises a second revolutions per minute control step of stopping an operation of the compressor when revolutions per minute of the compressor after waiting t seconds is lower than revolutions per minute in the predetermined low flow condition.
